(19) United States
(12) Patent Application Publication
(10) Pub. No.: US 2010/0157099 A1
(43) Pub. Date: Jun. 24, 2010

(54) MOBILE DEVICE WITH A CAMERA

(75) Inventor: Yutaka Nakai, Daito-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/645,329

(22) Filed: Dec. 22, 2009

(30) Foreign Application Priority Data
Dec. 22, 2008 (JP) 2008-326289

(51) Int. Cl. H04N 5/228; H04N 5/76

(52) U.S. Cl. 348/231.99; 348/222.1; 348/E05.031

(57) ABSTRACT

A mobile device with a camera is disclosed, which includes a first camera for obtaining first image information and a second camera arranged so as to be directed toward a photographer when photographing using the first camera. The mobile device further includes a storage unit storing the first image information sent from the first camera, and a control unit storing the first image information sent from the first camera in the storage unit based on second image information sent from the second camera, such as a state of a face image in an image photographed by the second camera. In a further embodiment, the control unit can store the first image information based on whether a level of a preliminarily set expression of the face image exceeds a threshold.

### CROSS-REFERENCE TO RELATED APPLICATION

The present application claims priority under 35 U.S.C. §119 to Japanese Application No. 2008-326289, filed on Dec. 22, 2008, entitled “MOBILE DEVICE WITH A CAMERA”. The content of which is incorporated by reference herein in its entirety.

### FIELD OF THE INVENTION

Embodiments of the present invention generally relate to mobile devices with a digital camera, and more particularly relate to a cellular phone with a digital camera, a personal digital assistant with a digital camera and the like.

### BACKGROUND

In recent years, most mobile phones are equipped with a camera function. A user can readily take a photograph using the mobile phone by activating a camera mode. In the case of photographing, usually, a button given to a shutter button is manipulated by a user. This allows that the shutter is clicked and a photographed image is retained in a memory in the mobile phone.

On the other hand, there have been developed cameras having automatic photographing techniques in which a face of an object and face expression thereof are detected to automatically click a shutter in response to them. Such automatic photographing techniques have also been applied to mobile phones with cameras.

Photographing circumstances such as objects, the number thereof, distances from cameras to the objects, and face directions of the objects are changed for each photographing.

Therefore, mobile devices with cameras such as mobile phones with cameras are required to be able to smoothly photograph scenes desired by photographers in various photographing circumstances.

### SUMMARY

The presently disclosed embodiments are directed to solving one or more of the problems presented in the prior art, as well as providing additional features that will become readily apparent by reference to the following detailed description when taken in conjunction with the accompanying drawings.

One embodiment of the present disclosure is directed to a mobile device with a camera. The mobile device includes a first camera and a second camera arranged so as to be directed toward a photographer when photographing using the first camera. The mobile device further includes a storage unit storing first image information sent from the first camera; and a control unit storing the first image information sent from the first camera in the storage unit based on second image information sent from the second camera.

Another embodiment of the present disclosure is directed to a method of photographing using a mobile device with a camera. The method includes obtaining first image information using a first camera, and arranging a second camera so as to be directed toward a photographer when photographing using the first camera. The method further includes storing the first image information sent from the first camera based on second image information sent from the second camera.

Yet another embodiment is directed to a computer-readable medium storing computer executable instructions that when executed perform a process of photographing using a mobile device with a camera. The process includes photographing using a first camera, and arranging a second camera so as to be directed toward a photographer when photographing using the first camera. In a further embodiment, the process includes storing the first image information sent from the first camera based on second image information sent from the second camera.

Further features and advantages of the present disclosure, as well as the structure and operation of various embodiments of the present disclosure, are described in detail below with reference to the accompanying drawings.

### BRIEF DESCRIPTION OF THE DRAWINGS

Embodiments of the present invention are hereinafter described in conjunction with the following figures, wherein like numerals denote like elements. The figures are provided for illustration and depict exemplary embodiments of the invention. The figures are provided to facilitate understanding of the invention without limiting the breadth, scope, scale, or applicability of the invention. The drawings are not necessarily made to scale.

FIG. 1A is a front view of a mobile phone in which a second cabinet is in an open state, according to one embodiment of the invention.

FIG. 1B is a side view of the mobile phone of FIG. 1A.

FIG. 1C is a sectional view taken along the line IC-IC of FIG. 1B.

FIG. 2 is a block diagram of the mobile phone shown in FIG. 1A, according to one embodiment of the invention.

FIG. 3 is a flow chart showing a flow of a photograph process in an automatic photographing mode, according to one embodiment.

FIG. 4 is plot diagram showing a level of smile with an exemplary threshold, with respect to time, according to one embodiment.

FIG. 5 is a view showing a layout example of a thumbnail screen of photo images photographed in the automatic photographing mode, according to one embodiment.

FIG. 6 is a block diagram of a mobile phone according to another embodiment.

FIG. 7 is a functional block diagram which is for performing an automatic photographing mode according to one embodiment.

FIG. 8A is a flow chart showing a flow of a photograph process in an expression collection mode according to another embodiment.

FIG. 8B is a flow chart showing a flow of a process of an expression setting registration according to one embodiment.

FIG. 9A is a view showing a setting registration screen for the expression setting registration according to one embodiment.

FIG. 9B provides a plurality of views each showing a registration confirmation screen for the expression setting registration according to one embodiment.

FIG. 10 is a flow chart showing a flow of a photograph process in the automatic photographing mode according to one embodiment.

FIG. 11 is a view showing a layout example of a thumbnail screen of photo images photographed in the automatic photographing mode according to one embodiment.

### DETAILED DESCRIPTION OF EXEMPLARY EMBODIMENTS

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the invention. Furthermore, there is no intention to be bound by any expressed or implied theory presented in the preceding technical field, background, brief summary or the following detailed description. The present disclosure should be accorded scope consistent with the claims, and not limited to the examples described and shown herein.

Embodiments of the invention are described herein in the context of one practical non-limiting application, namely, a mobile phone with a camera. Embodiments of the disclosure, however, are not limited to such mobile devices with a camera such as PHS (personal handy phone system) with a camera, PDA (personal digital assistance) with a camera, digital cameras and the like, and the techniques described herein may also be utilized in other applications of optical systems. For example, embodiments may be applicable to digital cameras, personal computers, and the like.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

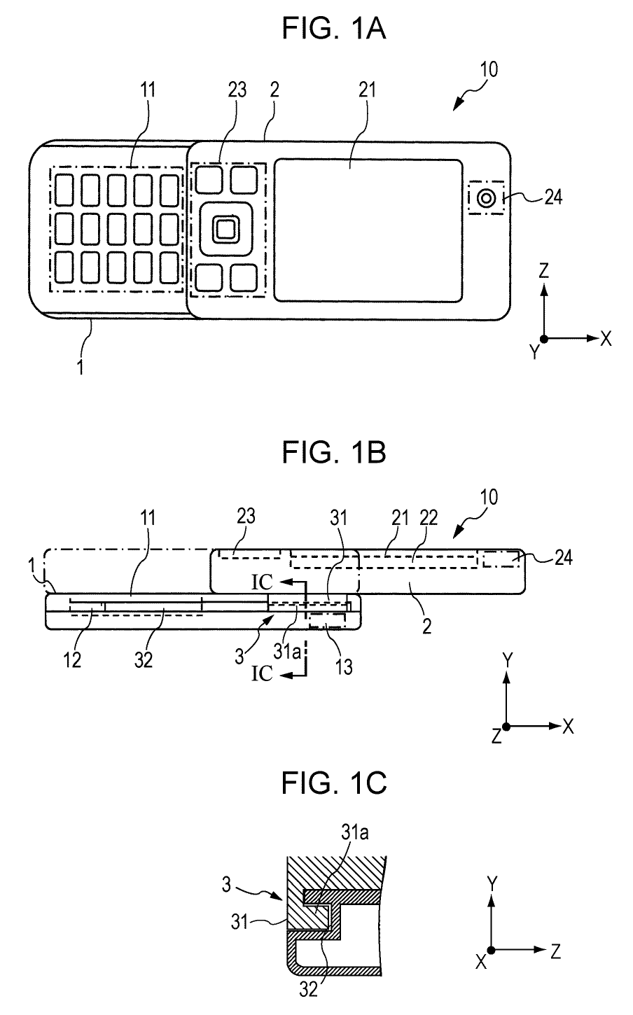

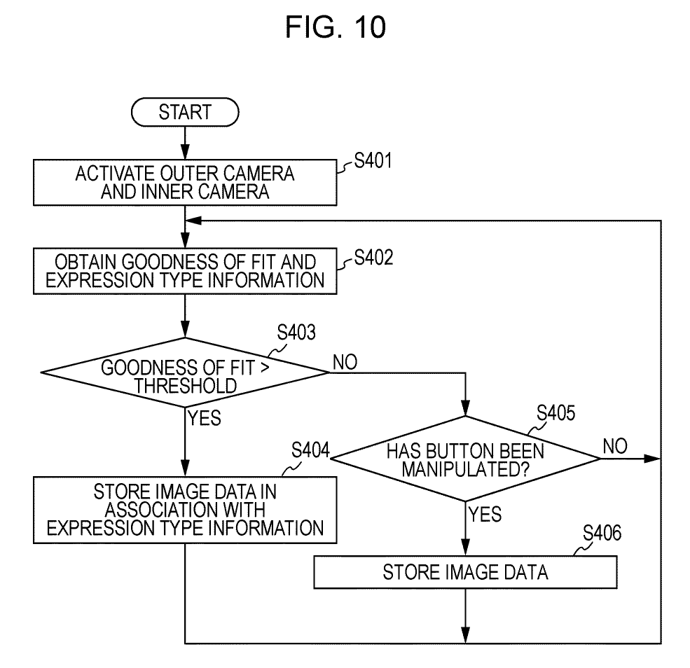

FIGS. 1A, 1B, and 1C are views each showing an appearance constitution of a mobile phone 10 according to a first embodiment. FIG. 1A is a front view of the mobile phone 10 in which a second cabinet is in an open state, and FIG. 1B is a side view in the same state. FIG. 10 is a sectional view taken along the line IC-IC of FIG. 1B.

The mobile phone 10 comprises a first cabinet 1 and a second cabinet 2. A numeric keypad 11 is arranged on the front side of the first cabinet 1. The numeric keypad 11 comprises a plurality of input keys of numbers and characters, a call start key, a call end key, and the like. A backlight device 12 for the numeric key pad 11 (hereinafter, referred to as “key backlight”) is arranged on the back side of the numeric keypad 11. The key backlight 12 comprises a light emitting diode (LED) serving as a light source to supply light to the numeric keypad 11. This allows a user to see a display given to each key even when the surrounding is dark.

An outer camera 13 (first camera) is arranged inside the first cabinet 1. The outer camera 13 is, for example, a camera module having several millions of pixels. A lens window (not shown in the figure) of the outer camera 13 is engaged on the back side of the first cabinet 1, and the outer camera 13 gets an photo image of an object through the lens window.

A display section 21 having a vertically elongated rectangle shape is arranged on the front side of the second cabinet 2, and a display face thereof is engaged on the front side. The display section 21 may be made using, for example, a liquid crystal panel and an organic electroluminescence (EL). A backlight device 22 for display section 21 (hereinafter, referred to as “display backlight”) is arranged on the back side of the display section 21. The display backlight 22 comprises an LED serving as a light source to supply light to the display section 21.

A main keypad 23 is further arranged on the front side of the second cabinet 2. The main keypad 23 comprises four mode keys, a movement key, and a decision key. The mode keys are for activating various functional modes (camera mode, mail mode, Internet mode, and phonebook mode); the movement key is for scrolling screens up/down and for moving focus; and the decision key is for performing various decision operations.

The numeric keypad 11 and the main keypad 23 may comprise a touch panel or a touch sensor.

An inner camera 24 (second camera) is arranged inside the second cabinet 2. The inner camera 24 has pixels lower than those of the outer camera 13, for example, a camera module having hundreds of thousands of pixels. A lens window (not shown in the figure) of the inner camera 24 is engaged on the front side of the second cabinet 2, and the inner camera 24 gets an image of an object through the lens window.

The outer camera 13 is used for normal photography in the camera mode. On the other hand, the inner camera 24 is mainly used for photographing an image of a user (caller) when calling by a video phone. In addition, the inner camera 24 is used for photographing a face of the user (photographer) in an automatic photographing mode that is one of the functions of the camera mode as described later.

The second cabinet 2 is connected slidably in an x-axis direction shown in FIGS. 1A, 1B, and 10 with respect to the first cabinet 1 by a slide mechanism unit 3. As shown in FIG. 1C, the slide mechanism 3 comprises a guide plate 31 and a guide groove 32. The guide plate 31 is arranged at both right and left ends of the back side (both ends in a z-axis direction shown in FIGS. 1A, 1B, and 1C) of the second cabinet 2, and has a projected line 31a at the lower end thereof. The guide groove 32 is arranged on the side of the first cabinet 1 along a sliding direction (the x-axis direction shown in FIGS. 1A, 1B, and 1C). The projected line 31a of the guide plate 31 is engaged with the guide groove 32.

In a closed state of the mobile phone 10, as shown by a dashed-dotted line in FIG. 1B, the second cabinet 2 is substantially completely overlapped on the first cabinet 1. In this state (closed state), all the keys of the numeric keypad 11 are hidden behind the second cabinet 2. The second cabinet 2 can be slid until the guide plate 31 reaches a termination position of the guide groove 32 (brought into an opened state). When the second cabinet 2 is completely opened, as shown in FIG. 1A, all the keys of the numeric keypad 11 are exposed to the outside.

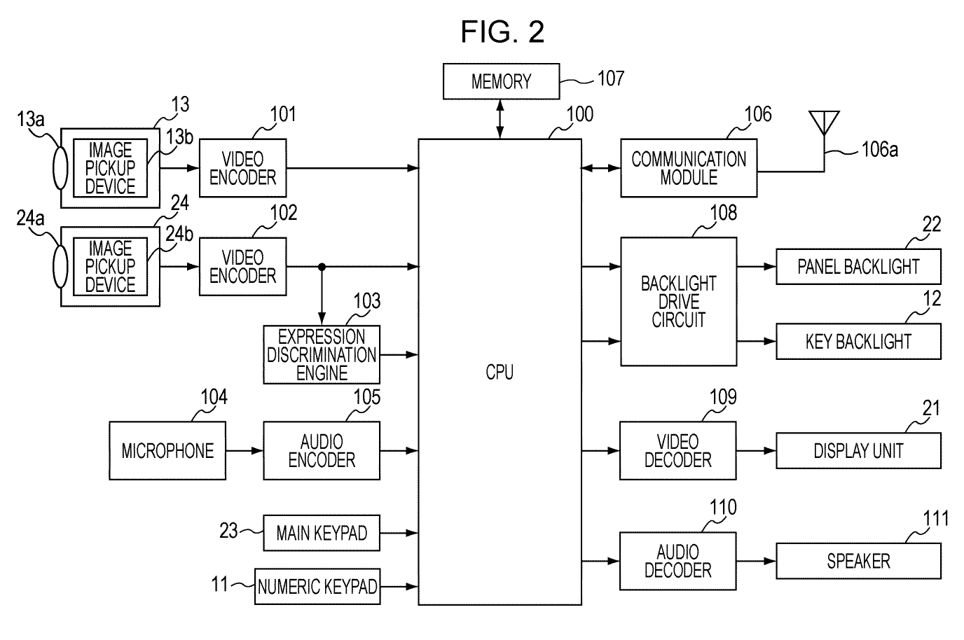

FIG. 2 is a block diagram showing the whole configuration of the mobile phone 10. The mobile phone 10 of the first embodiment comprises a CPU 100 (control unit), two video encoders 101 and 102, an expression discrimination engine 103, a microphone 104, an audio encoder 105, a communication module 106, a memory 107 (storage unit), a backlight drive circuit 108, a video decoder 109, an audio decoder 110, and a speaker 111, in addition to the above mentioned respective elements.

The outer camera 13 comprises an image pickup lens 13a, an image pickup device 13b, and the like. The image pickup lens 13a forms a photo image of an object onto the image pickup device 13b. The image pickup device 13b is, for example, a charge coupled device (CCD), which generates an image signal corresponding to a fetched image to output to the video encoder 101. The video encoder 101 converts the image signal sent from the image pickup device 13b into a digital image signal to output to the CPU 100, the digital image signal being processable by the CPU 100.

The inner camera 24 comprises an image pickup lens 24a an image pickup device 24b, and the like, and outputs an image signal corresponding to an image fetched by the image pickup device 24b to the video encoder 102 as in the outer camera 13. The video encoder 102 outputs a digitalized image signal to the CPU 100 as in the video encoder 101. In addition, the video encoder 102 outputs the image signal to the expression discrimination engine 103.

The expression discrimination engine 103 extracts a face image from the image photographed by the inner camera 24 on the basis of the image signal, and further calculates goodness of fit with respect to specific expression on the extracted face image to output to the CPU 100. The goodness of fit with respect to specific expression is, for example, smile level (a smile evaluation value).

Many sample images of the specific expression such as a smile face and a surprise face are preliminarily stored in the expression discrimination engine 103. For example, sample images of the whole face and each of parts such as an eye, a nose, and a mouth, are stored. The expression discrimination engine 103 evaluates the extracted face image based on the sample images using a predetermined evaluation method, and outputs the goodness of fit of the expression (an evaluation value).

Expression discrimination techniques using various evaluation methods can be applied to the expression discrimination engine 103. For example, the method of “Fischer's linear discriminant analysis” can be used; and accordingly, the extracted face image can be evaluated based on the sample images to find the goodness of fit. Alternatively, the method of “canonical discriminant analysis” can be used to evaluate so as to find the goodness of fit. Further alternatively, the method of template matching can be used to evaluate so as to find the goodness of fit.

The microphone 104 converts an audio signal such as a voice of the user into an electrical signal to output to the audio encoder 105. The audio encoder 105 converts the electrical audio signal sent from the microphone 104 into a digital audio signal to output to the CPU 100, the digital audio signal being processable by the CPU 100.

The communication module 106 converts the audio signal, the image signal, a text signal, and the like sent from the CPU 100 into radio signals to transmit to a base station via an antenna 106a. In addition, the communication module 106 converts the radio signals received via the antenna 106a into an audio signal, an image signal, a text signal, and the like to output to the CPU 100.

The memory 107 comprises a read only memory (ROM) and a random access memory (RAM). A control program for giving a control function to the CPU 100 is stored in the memory 107. In addition, image data photographed by the outer camera 13, image data downloaded from the outside via the communication module 106, text data (mail data), and the like are retained in the memory 107 in predetermined file formats.

The backlight drive circuit 108 supplies a voltage signal corresponding to a control signal sent from the CPU 100 to the display backlight 22 and the key backlight 12.

The video decoder 109 converts a video signal sent from the CPU 100 into an analog video signal to output to the display section 21, the analog video signal being able to be displayed on the display section 21.

The audio decoder 110 converts the digital audio signal sent from the CPU 100 into an analog audio signal to output to the speaker 111, the analog audio signal being able to be outputted by the speaker 111. The speaker 111 reproduces the analog audio signal sent from the audio decoder 110 as audio.

The CPU 100 outputs the control signals to respective units such as the communication module 106, the video decoder 109, and the audio decoder 110 on the basis of input signals sent from respective units such as the outer camera 13, the inner camera 24, the microphone 104, the main keypad 23, and the numeric keypad 11; and accordingly, various functional modes are processed.

For example, when the mode key of the camera mode is pressed, the CPU 100 activates the outer camera 13. Then, in the camera mode, the image sent from the outer camera 13 is displayed on the display section 21 as a preview image. Several tens of frame images per second are sent from the outer camera 13; and therefore, the images are displayed on the display section 21 in a substantially moving picture state.

When a shutter button (for example, the decision key) is pressed by the user, the CPU 100 stores an image photographed at this timing in the memory 107 in a predetermined file format such as the joint photographic experts group (JPEG).

The mobile phone 10 of the first embodiment comprises a function of the automatic photographing mode as one of the functions in the camera mode. The user can photograph not only by manipulating the shutter button, but also by utilizing the automatic photographing mode. In the first embodiment, the automatic photographing mode can be set by performing predetermined key manipulation. The automatic photographing mode can carry out to photograph automatically according to own face expression.

In the case where the automatic photographing mode is set, upon activation of the camera mode, the CPU 100 obtains goodness of fit (for example, smile level) with respect to a specific expression outputted from the expression discrimination engine 103. Then, a shutter is operated on the basis of the obtained goodness of fit (the smile level) to store in the memory 107 image data of an image photographed by the outer camera 13.

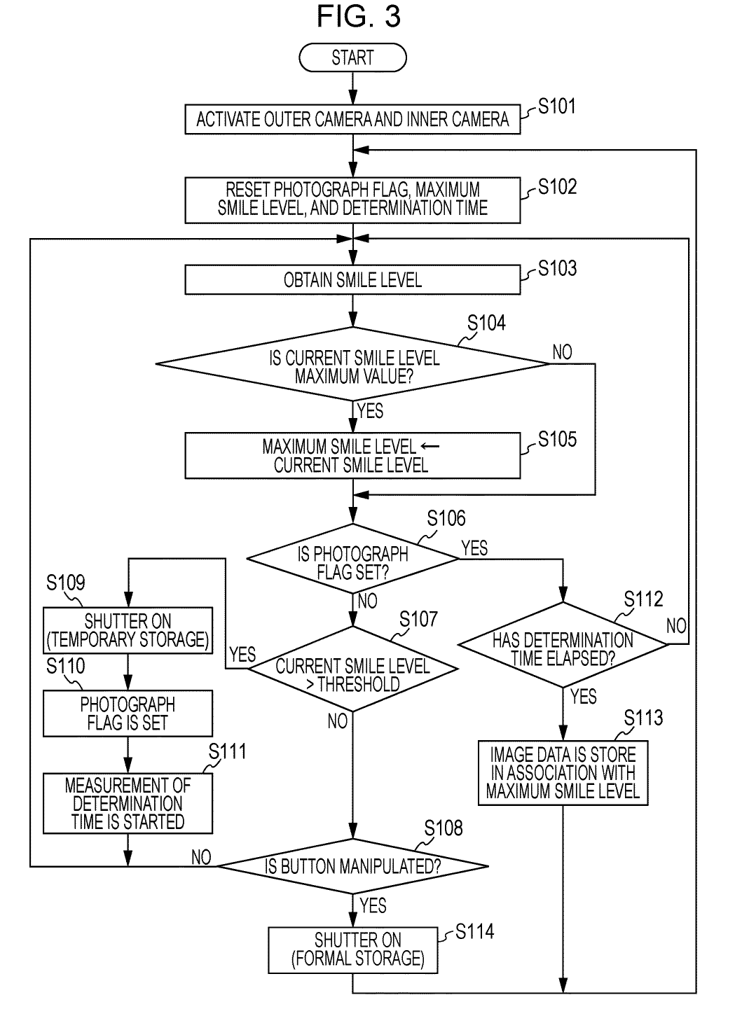

FIG. 3 is a flow chart showing a flow of a photograph process in the automatic photographing mode. In FIG. 3, a smile is used as the specific expression.

In the state where the automatic photographing mode is set, upon activation of the camera mode, the CPU 100 activates the outer camera 13 and the inner camera 24 (S101). This allows image signals of images photographed by the outer camera 13 and the inner camera 24 to be outputted from the respective cameras.

Next, the CPU 100 resets a photograph flag, maximum smile level, and determination time (S102). The photograph flag is used for determining whether or not a shutter has been already operated. The maximum smile level is a maximum value of the smile level to be described later. The determination time is a period for determining smile level of a photographer after the shutter is operated, and for example, is a period of a few seconds after a shutter operation.

When photographing of an object is started by the photographer, the object is photographed by the outer camera 13 and a photographed image is displayed on the display section 21 as a preview image. On the other hand, upon photographing, the photographer moves his/her face closer to the mobile phone 10 in order to watch the preview image; and therefore, the face of the photographer is photographed by the inner camera 24.

An image signal of the face image of the photographer photographed by the inner camera 24 is inputted to the expression discrimination engine 103, and smile level calculated from the face image of the photographer is outputted from the expression discrimination engine 103.

The CPU 100 obtains the smile level from the expression discrimination engine 103 (S103), and determines whether or not the obtained smile level is a maximum value (S104). That is, the CPU 100 determines that, if the obtained smile level is larger than the maximum smile level set at present, the smile level is the maximum smile level. When the smile level is detected first, the detected smile level is set as the maximum smile level. If the CPU 100 determines that, if the obtained smile level is determined as the maximum value (S104: YES), the smile level is set as the maximum smile level (S105).

Next, the CPU 100 determines whether or not a photograph flag is set (S106). If the shutter has not been operated yet, the photograph flag is in a reset state (S106: NO); and therefore, the CPU 100 determines whether or not the obtained smile level exceeds a threshold (S107).

When the CPU 100 determines that the obtained smile level does not exceed the threshold (S107: NO), the CPU 100 determines whether or not the shutter button has been manipulated (S108); and if the shutter button has not been manipulated (S108: NO), the process returns to step S103 to obtain new smile level. Thus, the CPU 100 repeats the process from step S103 to S108 until the obtained smile level exceeds the threshold (S107: YES) or the shutter button is manipulated (S108: YES). During this process, if the obtained smile level exceeds the maximum smile level (S104: YES), the maximum smile level is updated and set in each case (S105).

When the object such as a baby or pet performs funny motion or lovely motion, the photographer naturally smiles. Then, the funnier or lovelier the baby's or pet's motion is, the larger the smile of the photographer becomes. Such pleasant motion can be a photographing scene desired by the photographer.

When the face of the photographer has smile by pleasant motion performed by the object, the smile level increases to exceed the threshold. When the CPU 100 determines that the obtained smile level exceeds the threshold (S107: YES), the shutter is operated; and at that time, image data of the photo image photographed by the outer camera 13 is stored in a temporary storage area of the memory 107 (S109).

Next, the CPU 100 sets a photograph flag (S110), further starts to measure determination time (S111), and returns to the process in step S103. After that, since the photograph flag is set (S106: YES), the CPU 100 obtains the smile level (S103) and updates the maximum smile level (S105) until the CPU 100 determines that the determination time has elapsed (S112: YES).

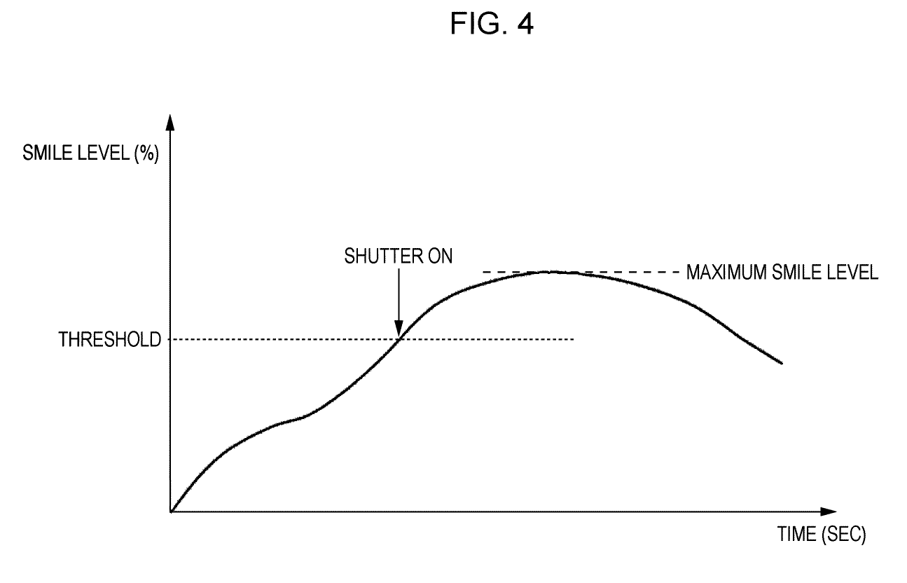

As shown in FIG. 4, in a normal case, the smile level increases for a while even after the shutter is operated when the smile level exceeds the threshold. In the first embodiment, the smile level of the photographer is measured for a while after the shutter is operated. It is therefore possible to obtain the maximum smile level of the photographer with respect to the photo image photographed at that time.

When the CPU 100 determines that the determination time has elapsed (S112: YES), the CPU 100 obtains the maximum smile level set at that time and formally stores the temporarily stored image data in the memory 107 in association with the maximum smile level (S113). Additional information including a file name, a photographed date and time, and a photographed place can be given to the image data in addition to the maximum smile level.

Besides, there is a case where the photographer manipulates the shutter button at a timing of his/her preference. In this case, the CPU 100 determines that the shutter button has been manipulated (S108: YES), and operates the shutter to formally store in the memory 107 the image data of the photo image photographed by the outer camera 13 at that time (S114).

When photography of one time is completed in such a manner (S113, S114), the CPU 100 returns to the process in step S102 again to reset the photograph flag, the maximum smile level, and the determination time, and newly starts the process from the step S103. Thus, the process of the automatic photographing mode is performed until the camera mode is stopped.

Expression for triggering shutter operation may not be smile as described above, but may be a surprise face, for example. In this case, surprise level is outputted from the expression discrimination engine 103 as the goodness of fit. Therefore, the shutter is clicked at the timing when the photographer is surprised, and image data thereof is stored. Alternatively, the expression may be a wink; and in that case, goodness of fit with respect to expression of wink is outputted from the expression discrimination engine 103. Therefore, the shutter is clicked at a timing when the photographer winks, and image data thereof is stored. A flow of the photograph process in the case where one of these expressions is applied is similar to the flow shown in FIG. 3.

Further, the user can preliminarily set a triggering expression from the plurality of expressions exemplified above. A plurality of expressions may be set as the triggering expression. In the case where a plurality of expressions are set, the photograph processes (the flows each shown in FIG. 3) corresponding to the respective expressions are executed in parallel.

In the first embodiment, a thumbnail list of the photo images can be displayed on the display section 21. More particularly, in the first embodiment, photo images photographed on the basis of the expression of the photographer in the automatic photographing mode are stored in the memory 107 in association with the specific levels of expression such as the smile level and the surprise level. Therefore, as one thumbnail display layout, it is possible to display a thumbnail classified by types of expression of the photographer and the levels of expression.

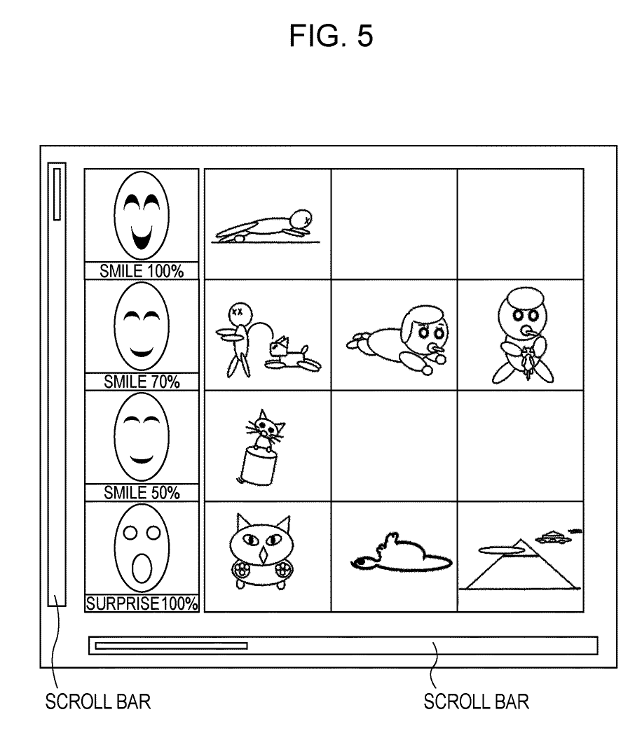

FIG. 5 is a view showing a layout example of a thumbnail screen of photo images photographed in the automatic photographing mode.

When manipulation for displaying the thumbnail is performed by the user (photographer), the CPU 100 displays index images corresponding to the levels of respective expressions as shown in FIG. 5. Then, thumbnails of the photo images to be classified into the index images are displayed beside the respective index images. For example, an index image may be an image with which, for example, face expression and numerical value (percentage) indicating level of expression are described.

In the layout example shown in FIG. 5, there are provided three classifications according to the levels of smile; a thumbnail of which the smile level is 100% is displayed beside an index image of “smile 100%”; thumbnails of which the smile level is equal to or larger than 70% and less than 100% are displayed beside an index image of “smile 70%”; and an thumbnail of which the smile level is equal to or larger than 50% and less than 70% is displayed beside an index image of “smile 50%”. The levels of surprise are also similarly classified. In FIG. 5, only the index image of “surprise level 100%” and the thumbnails corresponding thereto are shown. But, thumbnails corresponding to other levels of surprise can be displayed on the display section 21 by further scrolling the list screen downward using a scroll bar.

As described above, the expression of the photographer changes according to motion of the object; for example, there are many cases where the timing in which the face of the photographer shows smile or surprise expression can be identical with a timing in which the photographer desires to photograph. According to the first embodiment, photography can be performed at that timing; and therefore, photographs desired by the photographer can be taken.

According to the first embodiment, in the automatic photographing mode, the face of the photographer is photographed using the inner camera 24 and shutter operation (image storage) is performed on the basis of the face expression of the photographer. Therefore, camera shake during photography can be reduced.

According to the first embodiment, the expression discrimination engine 103 discriminates the expression of the photographer at the time of photographing. Therefore, the number of faces, a face position (distance to faces from the camera), a face direction, or the like to be discriminated is less likely to change according to photographing circumstances. Therefore, accurate discrimination of the expression can be made.

Further, according to the first embodiment, the photo images photographed using the outer camera 13 are stored in association with the expressions of the photographer at the time of photographing. Therefore, when the list of the thumbnail is displayed, it becomes possible to classify and display the thumbnails for respective expressions; and accordingly, convenience is improved for users.

According to the first embodiment, the inner camera 23 for use in video phones and the like is used as the camera for photographing the photographer. Therefore, a separate camera for exclusive use does not need to be provided, thereby requiring no largely increasing costs.

In the first embodiment, the face images serving as the criteria for expression discrimination are a plurality of general face images preliminarily prepared in the expression discrimination engine 103. In this case, appropriate discrimination accuracy can be obtained even when a face image to be an object of expression discrimination is different in each case. In addition, the expression discrimination engine 103 can use a general purpose expression recognition engine to reduce increasing costs.

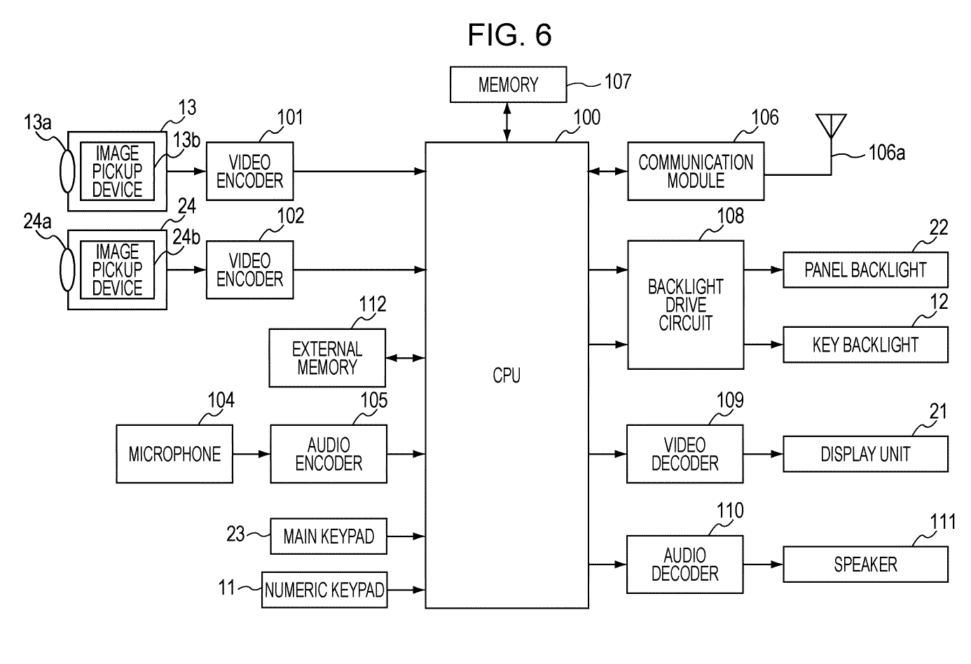

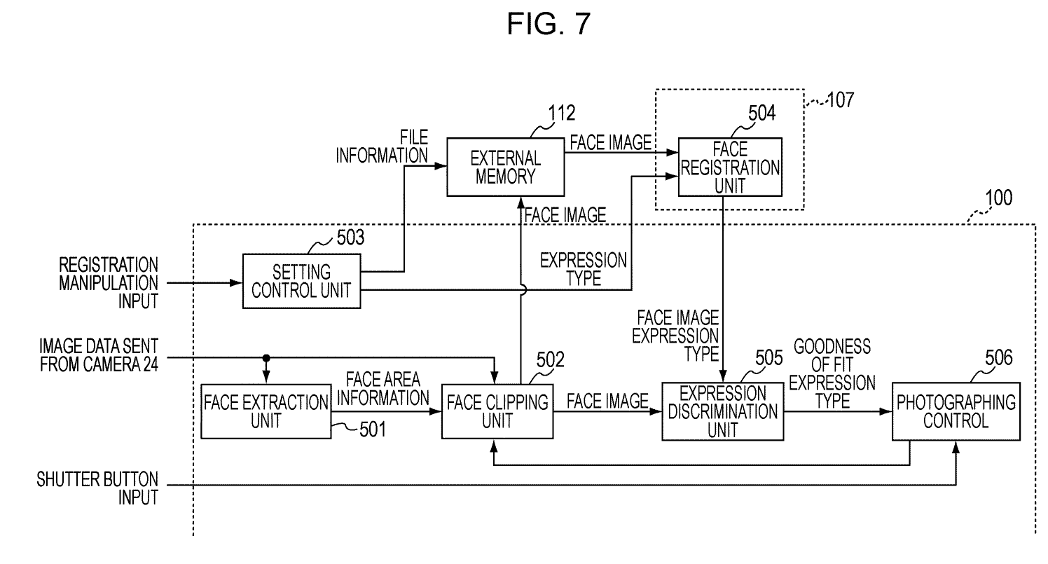

FIG. 6 is a block diagram showing the whole configuration of a mobile phone 10′ according to a second embodiment. In addition, FIG. 7 is a functional block diagram which is for performing an automatic photographing mode according to the second embodiment.

In the second embodiment, the mobile phone 10′ comprises an external memory 112 such as a secure digital (SD) card. The external memory 112 stores image data of photo images photographed by an outer camera 13 and an inner camera 24. Further, the mobile phone 10′ doesn't comprise the aforementioned expression discrimination engine 103, but a CPU 100 performs an expression discrimination process. The other configuration is the same as the above first embodiment.

As shown in FIG. 7, in order to perform the automatic photographing mode, the CPU 100 and a memory 107 include a face extraction unit 501, a face clipping unit 502, a setting control unit 503, a face registration unit 504, an expression discrimination unit 505, and a photographing control unit 506.

The face extraction unit 501, the face clipping unit 502, the setting control unit 503, the expression discrimination unit 505, and the photographing control unit 506 function as software to be executed by the CPU 100. The face registration unit 504 occupies part of a storage area of the memory 107.

The image data outputted from the inner camera 24 is inputted to the CPU 100 via a video encoder 102. The image data is obtained by the face extraction unit 501 and the face clipping unit 502.

The face extraction unit 501 obtains image data for one screen for each frame or for every several frames, and extracts a face image area (face area) contained in the image on the basis of the image data. For example, the face extraction unit 501 detects a flesh color in the image and further detects characterizing portions such as an eye, a nose, or a mouth on the basis of contrasts in the image or the like; and accordingly, the face area is extracted. Then, information for specifying the face area, such as position information of a face outline (hereinafter, referred to as “face area information”), is outputted to the face clipping unit 502. The image photographed by the inner camera 24 contains the face of a photographer; and in a normal case, one face area is extracted in one screen of image data outputted from the inner camera 24.

The face clipping unit 502 obtains image data for one screen and clips an image of a predetermined area containing the face area from the whole image for one screen on the basis of the face area information sent from the face extraction unit 501. Then, image data of the clipped face image is outputted to the expression discrimination unit 505.

When storage is instructed from the photographing control unit 506, the face clipping unit 502 reduces a data amount of the image data by decreasing the number of pixels of the image data of the face image clipped at the time, and then outputs to the external memory 112. The image data of the outputted face image is stored in the external memory 112 together with file information for specifying the face image.

The setting control unit 503 executes a control process of expression setting registration to be described later. In the control process, the setting control unit 503 outputs to the external memory 112 file information of a face image to be registered in the face registration unit 504 in response to registration manipulation input by a user and outputs expression type information given to the face image to the face registration unit 504. The expression type information is used for identifying to which expression such as a smile and a surprise face the face image belongs, and is given to a face image in response to the registration manipulation by the user.

When the external memory 112 receives the file information from the setting control unit 503, the external memory 112 outputs to the face registration unit 504 image data of a face image corresponding to the file information. The face registration unit 504 registers the image data of the face image outputted from the external memory 112 in association with the expression type information outputted from the setting control unit 503. Hereinafter, the face image registered in the face registration unit 504 is referred to as a “registered face image”.

When the image data of the face image is sent from the face clipping unit 502, the expression discrimination unit 505 reads out image data of all the registered face images from the face registration unit 504 together with the expression type information. Then, expression of the face image sent from the facing clipping unit 502 is checked against expression of each of the registered face images, to calculate goodness of fit with expression of the registered face image. For example, the shape of a part that is likely to be changed according to expression such as an eye, eyebrows, or a mouth is extracted from both of the face images; the goodness of fit for each of the parts is calculated; and then, all the goodness of fit is comprehensively considered to calculate final goodness of fit of the expression. Calculation of the goodness of fit for each of the parts can also be made using the aforementioned various evaluation methods. In order to use in the aforementioned check, the image data of the registered face image which the expression discrimination unit 505 reads out from the face registration unit 504 may be image data of only the shape of a part for use in the check in the image data of the registered face image.

Thus, when the goodness of fit with respect to each of the registered face images is calculated, the expression discrimination unit 505 outputs the expression type information of the registered face image whose goodness of fit is the highest and the goodness of fit in this case to the photographing control unit 506.

The goodness of fit obtained from the expression discrimination unit 505 is compared with a preliminarily set threshold; and accordingly, the photographing control unit 506 determines whether or not the expression of the photographer in the face image is the same as set specific expression to perform a photograph process on the basis of this determination result.

In the second embodiment, face images having various expressions of a user as a photographer can be used as the registered face images. Therefore, the mobile phone 10′ comprises an expression collection mode for collecting the face images of the various expressions of the user. When this mode is set by predetermined manipulation by the user, the photograph process for collecting the expressions is executed.

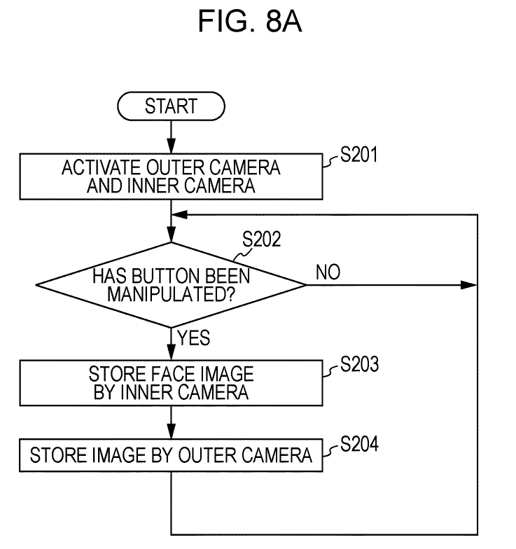

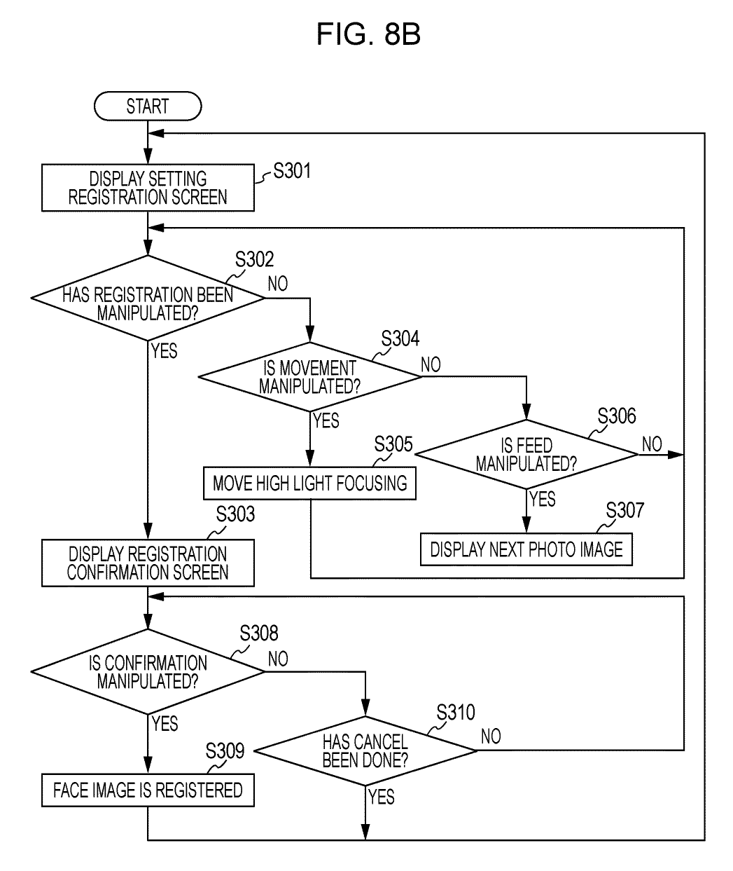

FIG. 8A is a flow chart showing a flow of the photograph process in the expression collection mode according to the second embodiment.

In a state where the expression collection mode is set, when the camera mode is activated, the photographing control unit 506 activates the outer camera 13 and the inner camera 24 (S201). This allows image signals of photo images photographed by the outer camera 13 and the inner camera 24 to be outputted from the respective cameras.

Next, the photographing control unit 506 determines whether or not the shutter button has been manipulated (S202). When the shutter button is manipulated by a photographer (user) (S203: YES), the photographing control unit 506 instructs storage to the face clipping unit 502 as described above. Then, image data of a face image of the photographer photographed by the inner camera 24 at that time is stored in the external memory 112 (S203). Further, the image data of the photo image of an object or the like photographed by the outer camera 13 is stored in the external memory 112 in association with file information of the face image of the photographer photographed by the inner camera 24 (S204).

Thus, the face image of the photographer at the time when the photograph is taken is stored in the external memory 112 together with the image data of the photo image every time the photographer photographs the object. There is thus stored the image data of the face images of the photographer having various expressions in the external memory 112.

Next, when a large number of the face images are collected, desirable one selected from among the collected face images is set and registered by a user as a face image serving as a discrimination criterion.

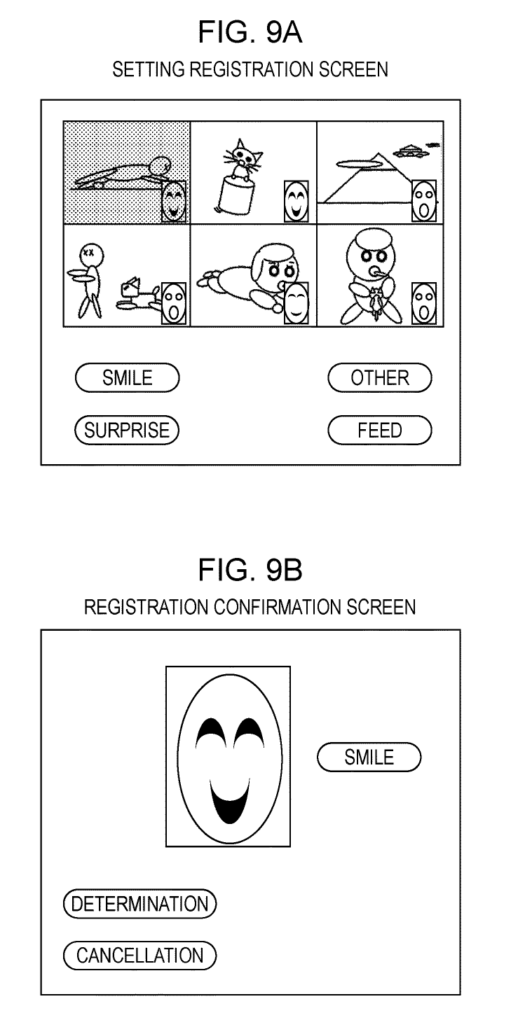

FIG. 8B is a flow chart showing a flow of a process of the expression setting registration according to the second embodiment. In addition, FIGS. 9A and 9B are views each showing a manipulation screen for the expression setting registration according to the second embodiment; FIG. 9A shows a setting registration screen, and FIG. 9B shows a registration confirmation screen.

When manipulation of the expression setting registration is started by a user, the control process of the expression setting registration is executed by the setting control unit 503.

The setting control unit 503 first displays the setting registration screen shown in FIG. 9A on the display section 21 (S301). At this time, the setting control unit 503 reads out the photo image to which the file information of the face image is given and the image data of the face image having the file information from the external memory 112. Then, a list of the photo images in which small face images are partly shown is displayed in the setting registration screen. Further, the setting control unit 503 allots four mode keys located on a main keypad 23 shown in FIG. 1 as keys for use in setting registration, for example, three registration keys of “smile,” “surprise,” and “other” to be used for registering by partitioning the face images for each expression, and a feed key. In order to show which mode key is allotted to which key, a display showing arrangement of three registration keys of “smile,” “surprise,” and “other” and the feed key is provided on the setting registration screen.

The user moves high light focusing to a face image to be registered using a movement key located in the main keypad 23, and manipulates a key allotted for expression to be registered among three registration keys. At that time, the user can refer to the photo image displayed together with the face image.

When the setting control unit 503 determines that any registration key has been manipulated (S302: YES), the setting control unit 503 displays the registration confirmation screen shown in FIG. 9B on the display section 21 (S303).

As shown in FIG. 9B, for example, the face image to be registered is enlarged and displayed on the registration confirmation screen; and expression type information corresponding to the formerly manipulated registration key is displayed beside the face image. In FIG. 3, smile is selected. Further, there is made a display showing arrangement of a determination key for determining registration and a cancel key for cancelling the registration. In this case, two mode keys corresponding to the displayed arrangement and located in the main key 23 are allotted as a determination key and a cancel key, respectively.

In a state shown in FIG. 9A, when the movement key located in the main keypad 23 is manipulated (S304: YES), the setting control unit 503 moves the high light focusing to a subsequent image in response to manipulation of the movement key (S305). When the feed key is manipulated (S306: YES), a plurality of photo images stored in the external memory 112 are displayed next to the plurality of photo images displayed at present (S307).

When the registration confirmation screen shown in FIG. 9B is displayed, the user confirms the expression of the face image in detail on the screen; and if the face image is good, the user manipulates the determination key. On the other hand, if the face image is not good and the registration is determined to be canceled as a result of detail confirmation, the user manipulates the cancel key.

When the setting control unit 503 determines that the determination key has been manipulated (S308: YES), as described above, the file information of the selected face image is outputted to the external memory 112 and expression type information to which the face image belongs is outputted to the face registration unit 504. This allows registration in the face registration unit 504 of the image data of the selected face image in association with the expression type information (S309).

Thus, when registration of one face image has been completed, the setting control unit 503 closes the registration confirmation screen to return to the process in step S301, displays the setting registration screen on the display section 21, and waits for new registration manipulation. Even when the setting control unit 503 determines that the cancel key has been manipulated (S310: YES), the setting control unit 503 closes the registration confirmation screen to return to the process in step S301, and displays the setting registration screen on the display section 21.

When manipulation for completing the setting registration is made by the user, the setting registration screen is closed to complete the setting registration process.

In doing so, the user can register a desired face image as the face image serving as the discrimination criterion for each expression, that is, as a registered face image. This allows the user to perform the automatic photographing mode using own face image.

FIG. 10 is a flow chart showing a flow of a photograph process in the automatic photographing mode according to the second embodiment.

In a state where the automatic photographing mode is set, when the camera mode is activated, the photographing control unit 506 activates the outer camera 13 and the inner camera 24 (S401). This allows image signals of images photographed by the outer camera 13 and the inner camera 24 to be outputted from the respective cameras.

In the inner camera 24, as described above, the face of the photographer (user) is photographed; and therefore, the highest goodness of fit with respect to the expression of the face image of the photographer at that time is sent from the expression discrimination unit 505 to the photographing control unit 506 together with the expression type information of the registered face image to be objected for each one frame or for every several frames.

When the photographing control unit 506 obtains the goodness of fit and the expression type information (S402), the photographing control unit 506 determines whether or not the obtained goodness of fit exceeds a preliminarily set threshold (S403).

For example, in a case where the face image of the photographer having expression type information of smile (registered face image of smile) is registered in the face registration unit 504, when the face of the photographer have smile by pleasant motion performed by the object, goodness of fit with respect to the registered face image of smile increases and exceeds the threshold. The threshold can be set individually for each of the expression type information.

When the photographing control unit 506 determines that obtained goodness of fit exceeds the threshold (S403: YES), the photographing control unit 506 operates the shutter and stores in the external memory 112 the image data of the photo image photographed by the outer camera 13 at that time in association with the expression type information (S404).

On the other hand, there is a case where the shutter button is manipulated at a time when the photographer desires. In this case, the photographing control unit 506 determines that the shutter button has been manipulated (S405: YES), performs operates the shutter, and stores the image data of the photo image photographed by the outer camera 13 at that time in the external memory 112 (S406).

In the case of performing automatic photographing based on the expression of the photographer (S404) and manual photographing using the shutter button (S406), the photographing control unit 506 may store the image data of the face image photographed by the inner camera 24 in the external memory 112. In this case, the file information of the face image photographed by the inner camera 24 is also given to the image data of the photo image photographed by the outer camera 13. This enables to register the face image photographed in the automatic photographing mode as a face image serving as a discrimination criterion.

In the second embodiment, the photo image photographed by the outer camera 13 is stored in the external memory 112 in association with the expression type information on a smile or surprise face. Therefore, a thumbnail display classified by the expression of the photographer can be performed as in the above first embodiment.

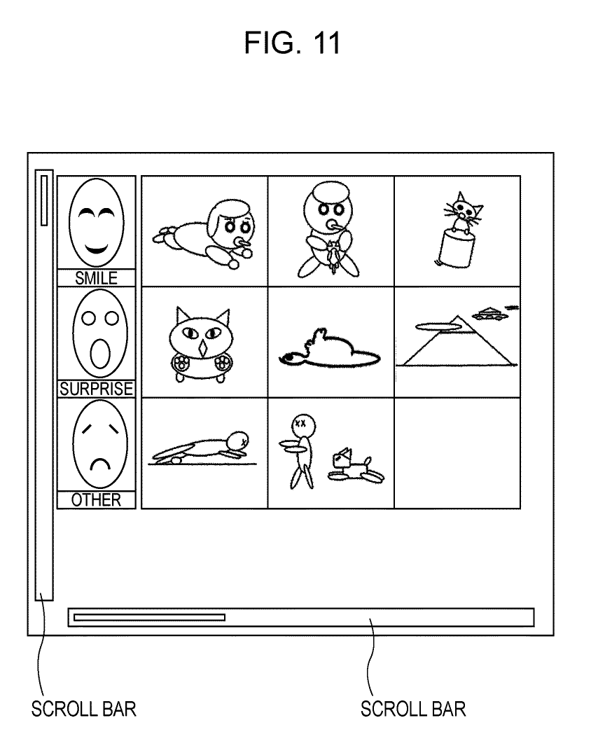

FIG. 11 is a view showing a layout example of a thumbnail screen of photo images photographed in the automatic photographing mode according to the second embodiment.

When manipulation for displaying the thumbnail is performed by the user (photographer), the photographing control unit 506 displays index images corresponding to respective expressions (for example, “smile,” “surprise,” and “other”) as shown in FIG. 11. Then, thumbnails of the photo image classified into the index images are displayed beside the respective index images. For example, the index images may comprise face images having respective expressions and expression names, and each of the face images having the respective expressions may utilize one of registered face images belonged to expression types of the respective expressions.

According to the second embodiment, expression discrimination can be performed using face images of the photographer (user) himself/herself. Therefore, it becomes possible to highly accurately discriminate expressions as compared to the case using general face images, that is, preinstalled face images.

In addition, according to the second embodiment, the face image photographed by the inner camera 24 during photography by the outer camera 13 (during image storage) is utilized as the face image serving as the discrimination criterion. Therefore, a face image having natural expression can be set as the face image serving as the discrimination criterion, and discrimination accuracy can be enhanced as compared to a case where intentional expression is photographed to serve as the discrimination criterion.

In the second embodiment, the mobile phone 10′ may comprise an expression discrimination engine 103 as in the above first embodiment. This allows the mobile phone 10′ to perform automatic photographing on the basis of an output sent from the expression discrimination engine 103. This enables to perform automatic photographing based on the expression of a photographer even when a person whose face image is not registered in the face registration unit 504 serves as a photographer.

Furthermore, in the second embodiment, the face image serving as the discrimination criterion is selected from the face images photographed by the inner camera 24 during manual photographing using the outer camera 13. However, a face image serving as the discrimination criterion may use the face image photographed by the inner camera 24 during photographing using the outer camera 13 in other modes such as the automatic photographing mode.

In addition, not only a face image photographed by the inner camera 24 as described above, but also a face image photographed by the outer camera 13 or obtained by other method such as via communication lines may be registered in the face registration unit 504 as a registered face image.

In the above first embodiment, when the shutter is operated, the image data sent from the outer camera 13 is temporarily stored in a temporary storage area of the memory 107, and is formally stored in the memory 107 after elapse of discrimination time. However, the image data sent from the outer camera 13 may be formally stored in the memory 107 by performing predetermined storage manipulation by users or the like after elapse of the determination time. That is, the image data sent from the outer camera 13 may not be formally stored in the memory 107 by cancelling predetermined storage manipulation by users.

Further, in the second embodiment, when the shutter is operated, the image data sent from the outer camera 13 is immediately stored formally in the external memory 112. However, the image data sent from the outer camera 13 may be temporarily stored in a temporary storage area provided in the memory 107 or the like; and then, the image data may be formally stored in the external memory 112 by performing predetermined storage manipulation by a user or the like. In this case, the temporary storage area corresponds to the aforementioned storage unit.

Moreover, the image data sent from the inner camera 24 may also be formally stored in the external memory 112 after having been temporarily stored in the temporary storage area, as in the above description.

Furthermore, in the above first embodiment, a photographing mode of photography by the outer camera 13 performed on the basis of a face image photographed by the inner camera 24 is the automatic photographing mode in which the shutter is automatically operated. However, the photographing mode of photography by the outer camera 13 performed on the basis of the face image photographed by the inner camera 24 may be a manual photographing mode in which the shutter is manually operated. In this case, timing of the shutter operation calculated on the basis of the face image photographed by the inner camera 24, that is, timing in which goodness of fit exceeds a threshold, is notified to the photographer. The photographer operates the shutter upon receiving such notification. Also in this case, photographing is performed at the above timing; and therefore, desired photographing can be performed by the photographer. As for a notification method to the photographer, text information may be displayed on the display section 21.

In the above first embodiment, there is exemplified as the automatic photographing mode comprised in the mobile phone 10, only the automatic photographing mode based on image information of the inner camera 24. However, the mobile phone 10 may be provided with an automatic photographing mode by using a conventional photographing process in addition to the above automatic photographing mode.

A “computer,” as referred to herein may include any number of devices or device combinations as known in the art. These include, for example, general purpose processors, content addressable memory modules, digital signal processors, application-specific integrated circuits, field programmable gate arrays, programmable logic arrays, discrete gate or transistor logic, or other such electronic components. The steps of a method or algorithm described in connection with the embodiments disclosed herein may be embodied directly in hardware, in firmware, in software, or in any combination thereof.

As used herein, the terms “computer program product”, “computer-readable medium”, and the like, generally refer to media such as, memory storage devices, or storage unit (e.g., floppy disks, CD's, etc.). These, and other forms of computer-readable media, may be involved in storing one or more instructions for use by a processor to cause the processor to perform specified operations. Such instructions, generally referred to as “computer program code” (which may be grouped in the form of computer programs or other groupings), when executed, enable a computing system.

While at least one exemplary embodiment has been presented in the foregoing detailed description, the present invention is not limited to the above-described embodiment or embodiments. Variations may be apparent to those skilled in the art. In carrying out the present invention, various modifications, combinations, sub-combinations and alterations may occur in regard to the elements of the above-described embodiment insofar as they are within the technical scope of the present invention or the equivalents thereof. The exemplary embodiment or exemplary embodiments are examples, and are not intended to limit the scope, applicability, or configuration of the invention in any way. Rather, the foregoing detailed description will provide those skilled in the art with a template for implementing the exemplary embodiment or exemplary embodiments. It should be understood that various changes can be made in the function and arrangement of elements without departing from the scope of the invention as set forth in the appended claims and the legal equivalents thereof. Furthermore, although embodiments of the present invention have been described with reference to the accompanying drawings, it is to be noted that changes and modifications may be apparent to those skilled in the art. Such changes and modifications are to be understood as being included within the scope of the present invention as defined by the claims.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A mobile device with a camera, comprising:
a first camera;
a second camera arranged so as to be directed toward a photographer when photographing using the first camera;
a storage unit storing first image information sent from the first camera; and
a control unit storing the first image information sent from the first camera in the storage unit based on second image information sent from the second camera.

2. The mobile device with the camera according to claim 1, wherein
the control unit stores the first image information sent from the first camera in the storage unit based on a state of a face image in an image photographed by the second camera.

3. The mobile device with the camera according to claim 2, wherein
the control unit stores the first image information sent from the first camera in the storage unit based on whether an expression of the face image is included in a preliminarily set expression.

4. The mobile device with the camera according to claim 3, wherein
the control unit stores the first image information sent from the first camera in the storage unit based on whether a level of the expression of the face image in the preliminarily set expression exceeds a threshold.

5. The mobile device with the camera according to claim 2, wherein
the control unit associates face state information related to the state of the face image with the first image information when storing the first image information in the storage unit.

6. The mobile device with the camera according to claim 2, wherein
the control unit sets a reference face image serving as a discrimination criterion, and discriminates the state of the face image based on the reference face image.

7. The mobile device with the camera according to claim 6, wherein
the control unit sets the reference face image based on external manipulation.

8. The mobile device with the camera according to claim 6, wherein
the control unit obtains a face image which can be a candidate for the reference face image from the image photographed by the second camera when photographing using the first camera.

9. A method of photographing using a mobile device with a camera, comprising:
obtaining first image information using a first camera;
arranging a second camera so as to be directed toward a photographer when photographing using the first camera; and
storing the first image information sent from the first camera based on second image information sent from the second camera.

10. The method according to claim 9, wherein
the first image information sent from the first camera is stored based on a state of a face image in an image photographed by the second camera.

11. The method according to claim 10, wherein
the first image information sent from the first camera is stored based on whether an expression of the face image is included in a preliminarily set expression.

12. The method according to claim 11, wherein
the first image information sent from the first camera is stored based on whether a level of the expression of the face image in the preliminarily set expression exceeds a threshold.

13. The method according to claim 10, further comprising:
associating face state information related to the state of the face image with the first image information when storing the first image information.

14. The method according to claim 10, further comprising:
setting a reference face image serving as a discrimination criterion; and
discriminating the state of the face image based on the reference face image.

15. The method according to claim 14, further comprising:
setting the reference face image based on external manipulation.

16. The method according to claim 14, further comprising:
obtaining a face image which can be a candidate for the reference face image from the image photographed by the second camera when photographing using the first camera.

17. A computer-readable medium storing computer-executable instructions thereon that, when executed, perform a process of photographing using a mobile device with a camera, comprising:
photographing using a first camera;
arranging a second camera so as to be directed toward a photographer when photographing using the first camera; and
storing the first image information sent from the first camera based on second image information sent from the second camera.

18. The computer-readable medium according to claim 17, wherein
the first image information sent from the first camera is stored based on a state of a face image in an image photographed by the second camera.

19. The computer-readable medium according to claim 18, wherein
the first image information sent from the first camera is stored based on whether an expression of the face image is included in a preliminarily set expression.

20. The computer-readable medium according to claim 19, wherein
the first image information sent from the first camera is stored based on whether a level of the expression of the face image in the preliminarily set expression exceeds a threshold.

21. The computer-readable medium according to claim 18, wherein the process further comprises:
associating face state information related to the state of the face image with the first image information when storing the first image information.

22. The computer-readable medium according to claim 18, wherein the process further comprises:
setting a reference face image serving as a discrimination criterion; and
discriminating the state of the face image based on the reference face image.

23. The computer-readable medium according to claim 22, wherein the process further comprises:
setting the reference face image based on external manipulation.

24. The computer-readable medium according to claim 22, wherein the process further comprises:
obtaining a face image which can be a candidate for the reference face image from the image photographed by the second camera when photographing using the first camera.
